(19) United States
(12) Patent Application Publication
(10) Pub. No.: US 2024/0308489 A1
(43) Pub. Date: Sep. 19, 2024

(54) SYSTEM FOR CONTROLLING PARKING BRAKE AND METHOD OF CONTROLLING RELEASE OF PARKING BRAKE

(71) Applicants: Hyundai Motor Company, Seoul (KR); Kia Corporation, Seoul (KR)

(72) Inventor: Seung-Hwan YANG, Jeonju-Si (KR)

(73) Assignees: Hyundai Motor Company, Seoul (KR); Kia Corporation, Seoul (KR)

(21) Appl. No.: 18/238,985

(22) Filed: Aug. 28, 2023

(30) Foreign Application Priority Data
Mar. 14, 2023 (KR) 10-2023-0033033

(51) Int. Cl. B60T 13/68; B60T 13/26

(52) U.S. Cl. CPC B60T 13/683; B60T 13/261

(57) ABSTRACT

A system for controlling a parking brake may include an air compressor that generates compressed air, an air dryer that transmits the compressed air, a pressure protection valve that supplies the compressed air from the air dryer to a service brake flow path connected to a spring brake chamber of a brake and a parking brake flow path, an additional parking brake flow path connected between the air dryer and the pressure protection valve, a double check valve including first and second inputs connected to the additional parking brake flow path and the parking brake flow path respectively, and transmitting a higher pressure among a first input pressure of the first input and a second input pressure of the second input through an output port of the double check valve, and a parking valve which is provided on a flow path connected from the output port of the double check valve to a parking port of the spring brake chamber and is configured to control a parking brake operation of the brake-rear.

### CROSS-REFERENCE(S) TO RELATED APPLICATIONS

The present application claims priority to Korean Patent Application No. 10-2023-0033033, filed on Mar. 14, 2023, the entire contents of which is incorporated herein for all purposes by this reference.

### BACKGROUND OF PRESENT DISCLOSURE

### Field of Present Disclosure

The present disclosure relates to a system for controlling a parking brake of a vehicle and a method of controlling release of a parking brake.

### Description of Related Art

A parking brake is not a service brake which is operated by pedaling with the foot while driving, but is a brake that prevents the vehicle from moving when stopping or parking.

FIG. 1 shows a brief system diagram for controlling a brake-rear, which controls the service brake and the parking brake by a pneumatic circuit such as a diagram.

A system for controlling includes an air compressor 11, an air dryer 12, a pressure protection valve 20, a first air tank 31, a second air tank 32, an auxiliary air tank 33, a first brake 41, and a second brake 42, and the first brake 41 may be a brake-rear and the second brake 42 may be a brake-front.

A dual brake valve 50 is provided on paths to the first brake 41 and the second brake 42, and a parking valve 60 is included for parking brake control.

A spring chamber 43 of the first brake 41 is divided into a parking P chamber and a service S chamber. When the parking brake is applied (when a parking valve is operated), compressed air from the parking chamber P of spring chamber 43 leaks through the exhaust of the parking valve 60, and then the expansion of a spring which was compressed due to the compressed air moves a push rod of the spring chamber 43 into the brake 41 to generate braking force.

Furthermore, when driving or releasing parking brake for departure, the spring is compressed by forming compressed air in the parking chamber P of the spring chamber 43 and the braking force is released by returning the push rod of the chamber.

The process of forming the compressed air in the system is as follows. The compressed air generated from the air compressor 11 passes through the air dryer 12 and is delivered to the pressure protection valve 20 (four-circuit protection valve), and the compressed air is delivered to each pneumatic circuit through the valve 20.

At the present time, to transmit compressed air for each circuit in the pressure protection valve 20, a pressure must be formed to be greater than or equal to an opening pressure capable of opening a valve diaphragm for each circuit.

The pressure protection valve 20 is connected to a service brake flow path 21 supplying pneumatic pressure to the brake 41, a parking brake flow path 23, a second brake flow path 22 supplying pneumatic pressure to the brake 42, and an auxiliary flow path 24 supplying pneumatic pressure to an air suspension or the like.

An opening pressure of the parking brake flow path 23 is relatively higher than the pressure of other circuits (parking may be released after stable service brake pressure is formed).

For example, 21, 22, and 24 circuits have an opening pressure of 6.5 bar, and a 23 circuit has an opening pressure of 7.0 bar.

When pressure of the corresponding circuit is lowered by frequently using compressed air, the pressure protection valve 20 closes a diaphragm to protect a circuit of the other port.

Therefore, when compressed air generated by the air compressor 11 exceeds the opening pressure, the compressed air is transmitted to the 21, 22, and 24 circuits, and when the pressure rises and is greater than or equal to an opening pressure of the 23 circuit (parking brake pneumatic circuit), the compressed air is transmitted to the 23 circuit.

Due to the present process, pressure formation of a parking brake circuit is delayed compared to other circuits when the air compressor 11 is operated.

Therefore, when a driver frequently brakes, an air tank pressure in the 21 and 22 circuits decreases, and when pressure in the tank decreases, the air dryer 12 can transmit compressed air generated by the air compressor 11 to the circuit. When pressure of a system circuit exceeds cut-out pressure (9.3 bar), the air dryer 12 closes the system circuit while discharging the compressed air to the exhaust of the air dryer 12 through a process called purging. In the present way, the system pressure is maintained after the air dryer 12, and when the pressure in the circuit decreases as the driver utilizes compressed air, the air dryer 12 opens the circuit again to transmit the compressed air to increase the system pressure.

For example, in a case where the cut-out pressure is 9.3 bar and an operation range is 1 bar, when compressed air reaches 9.3 bar, system pressure for each circuit is maintained by an air dryer purge operation, when the system pressure is lowered by more than 1 bar (operating range) due to the use of the compressed air, the air dryer 12 opens an internal valve and transmits the compressed air again to the circuit until the cut-out pressure. The system pressure is maintained at an appropriate level by repeating the present process.

However, due to frequent brake applications, when the vehicle stops (for example, stop in front of a traffic light) while the system pressure is low, the driver can apply the parking brake.

Because compressed air is released into the atmosphere when the parking brake is applied, to release the parking brake, a parking brake pressure in the parking brake circuit must be greater than or equal to a parking brake release pressure. However, in a case where a parking tank is not separate, parking may not be released due to insufficient air capacity in a parking circuit when the system pressure is low.

That is, additional pressure must be formed in the parking brake circuit to release the parking brake, since the parking circuit has a relatively high opening pressure level in the pressure protection valve 20, the parking circuit may be filled with compressed air only after the other circuits is filled.

Furthermore, in a case where an air tank capacity is large, it takes more time to fill the compressed air to increase the system pressure, so it takes more time to release the parking brake.

Accordingly, in a case where the parking circuit lacks air capacity, or a main brake and the parking brake are used frequently, when the vehicle starts after stopping with the parking brake, it takes time to form a pressure for releasing the parking brake, which may cause a vehicle departure delay problem.

That is, in a case where the system pressure is low (below opening pressure) and the pressure in the parking brake circuit is lower than a parking brake release pressure, to release the parking brake, the other circuits 21, 22, and 24 must be filled greater than or equal to the opening pressure for each circuit, and when total system pressure is greater than or equal to an opening pressure of the parking brake circuit, the pressure is transmitted to the parking brake circuit to release the parking brake.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system for controlling a parking brake and a method of controlling release of a parking brake which is configured for solving a time delay problem by transmitting compressed air to a parking brake circuit before reaching opening pressure of the parking brake circuit when system pressure is greater than or equal to an opening pressure of other circuits.

A system for controlling a parking brake according to an aspect of the present disclosure includes an air compressor that generates compressed air, an air dryer that transmits the compressed air, and a pressure protection valve that supplies the compressed air from the air dryer to a service brake flow path connected to a spring brake chamber of a brake-rear and a parking brake flow path, and includes an additional parking brake flow path connected between the air dryer and the pressure protection valve, a double check valve including first and second inputs connected to the additional parking brake flow path and the parking brake flow path respectively, and transmitting a higher pressure among a first flow path pressure of the first input and a second flow path pressure of the second input through an output port of the double check valve and a parking valve which is provided on a flow path connected from the output port of the double check valve to a parking port of the spring brake chamber and controls a parking brake operation of a brake-rear.

As an exemplary embodiment of the present disclosure, the system for controlling the parking brake may further include a solenoid valve provided on the additional parking brake flow path and a controller electrically connected to the solenoid valve and configured for controlling a supply of the compressed air through the additional parking brake flow path by controlling the solenoid valve.

As an exemplary embodiment of the present disclosure, in addition, the system for controlling the parking brake may further include a parking switch provided on the flow path connected from the output port of the double check valve to the parking port to detect a parking brake operation state of the brake-rear.

As an exemplary embodiment of the present disclosure, in addition, the system for controlling the parking brake may further include an additional parking flow path pressure sensor provided on the additional parking brake flow path to detect the first flow path pressure and a service flow path pressure sensor provided on the service brake flow path.

As an exemplary embodiment of the present disclosure, accordingly, the controller may be configured for controlling the solenoid valve according to the first flow path pressure of the additional parking flow path pressure sensor and a flow path pressure of the service flow path pressure sensor.

As an exemplary embodiment of the present disclosure, in addition, when the parking valve is operated, the controller may turn off the solenoid valve to supply the compressed air from port 23 to the parking valve through the parking brake flow path.

As an exemplary embodiment of the present disclosure, in particular, when the parking valve is released after operation thereof, and accelerator pedal operation and vehicle velocity are detected as zero, the controller may compare the first flow path pressure of the additional parking flow path pressure sensor and the flow path pressure of the service flow path pressure sensor, and when the first flow path pressure of the additional parking brake flow path is greater than or equal to the flow path pressure of the service brake flow path, the controller may turn on the solenoid valve to supply the compressed air to the parking port via the parking valve through the additional parking brake flow path.

As an exemplary embodiment of the present disclosure, in addition, the controller may turn off the solenoid valve to maintain when the flow path pressure of the service brake flow path is less than an opening pressure of the service brake flow path even in a state where the parking valve is released after operation thereof, accelerator pedal operation and vehicle velocity are detected as zero, and the first flow path pressure of the additional parking flow path is greater than or equal to pressure value of the service brake flow path.

As an exemplary embodiment of the present disclosure, in addition, after the controller turns on the solenoid valve, when flow path pressure of the additional parking flow path is greater than or equal to an opening pressure of the parking brake flow path, the controller may turn off the solenoid valve to supply the compressed air to the parking valve through the parking brake flow path.

Next, a method of controlling release of a parking brake according to an aspect of the present disclosure is based on the system for controlling the parking brake and includes: determining whether a vehicle velocity is greater than zero when the parking valve is released and accelerator pedal operation is detected; comparing, by the additional parking flow path pressure sensor and the service flow path pressure sensor, pressure values when the vehicle velocity is detected as zero; and supplying, by controlling the solenoid valve to turn on, the compressed air through the additional parking brake flow path when the first flow path pressure of the additional parking brake flow path is greater than or equal to the flow path pressure of the service brake flow path.

As an exemplary embodiment of the present disclosure, in addition, the method of controlling release of the parking brake may further include comparing the first flow path pressure of the additional parking brake flow path with an opening pressure of the parking brake flow path after the supplying of the compressed air through the additional parking brake flow path; and supplying, by controlling the solenoid valve to turn off, the compressed air through the parking brake flow path when the first flow path pressure of the additional parking flow path is greater than or equal to an opening pressure of the parking brake flow path.

As an exemplary embodiment of the present disclosure, in addition, the method of controlling release of the parking brake may further include determining whether the flow path pressure of the service brake flow path is greater than or equal to an opening pressure of the service brake flow path before the comparing of pressure values by the additional parking flow path pressure sensor and the service flow path pressure sensor when the vehicle velocity is detected as zero by the determining of whether the vehicle velocity is greater than zero, wherein when the flow path pressure of the service brake flow path is greater than or equal to the opening pressure of the service brake flow path, comparing the first flow path pressure of the additional parking flow path pressure sensor and the flow path pressure of the service flow path pressure sensor is performed.

According to the system for controlling the parking brake and the method of controlling release of the parking brake of the present disclosure, when pressure in the parking brake circuit is low, it can contribute improving a parking brake release delay by reducing a parking release pressure formation time.

That is, the parking release delay problem may be improved while the stability of a service brake performance is secured.

Furthermore, when implementing autonomous driving in the future, it is possible to maintain a stationary state using a service brake or a parking brake to implement idle stop & to (ISG) functionality and when a vehicle is stopped during a smart cruise control (SCC) function, stop conditions may be implemented using the service brake or the parking brake. In a case where a frequent braking is required in a system such as the SCC, not by the driver, the system pressure is bound to be lowered. Accordingly, at the time of departure after the vehicle is suspended by the parking brake, the current system requires system pressure formation above the opening pressure of the parking circuit to release the parking brake due to a different opening pressure structure of each circuit, being inevitable the parking brake release delay (opening pressure: 23 parking circuit >21, 22, and 24 circuits).

However, for system circuits with the opening pressure greater than the parking brake release pressure (which is a general case), only a lower opening pressure than the parking circuit needs to be reached, so that the parking brake release delay is improved relatively rapidly.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a system for controlling a parking brake in the related art.

FIG. 2 schematically illustrates a system for controlling a parking brake according to an exemplary embodiment of the present disclosure.

FIG. 3, FIG. 4, and FIG. 5 are views exemplarily illustrating an operating state where the system for controlling the parking brake according to an exemplary embodiment of the present disclosure.

FIG. 6 illustrates a method of controlling release of a parking brake according to an exemplary embodiment of the present disclosure.

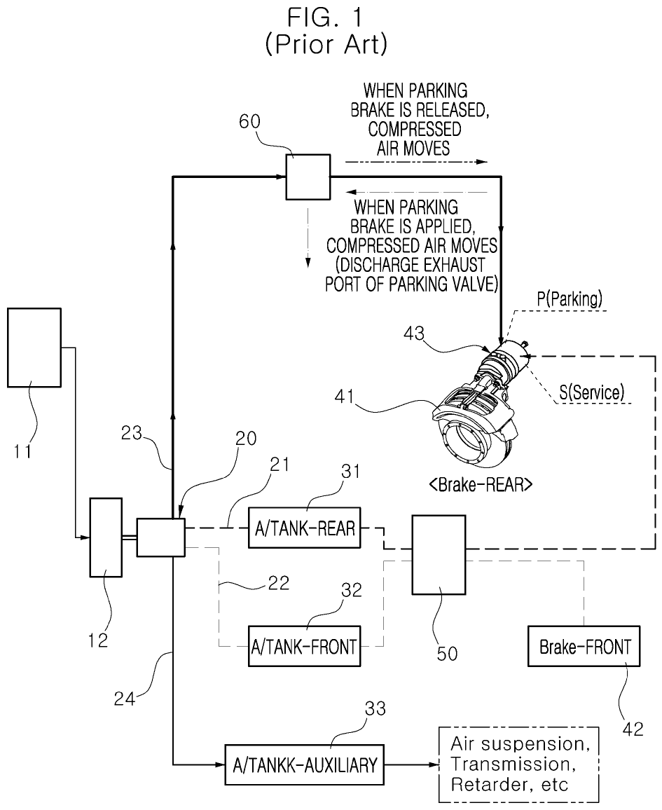

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The accompanying drawings illustrating a desired embodiment of the present disclosure and the contents described in the accompanying drawings should be referred, to fully understand the operational advantages of the present disclosure and the object achieved by an exemplary embodiment of the present disclosure.

In describing a desired embodiment of the present disclosure, a well-known technique or repeated description which may unnecessarily obscure the gist of the present disclosure will be reduced or omitted.

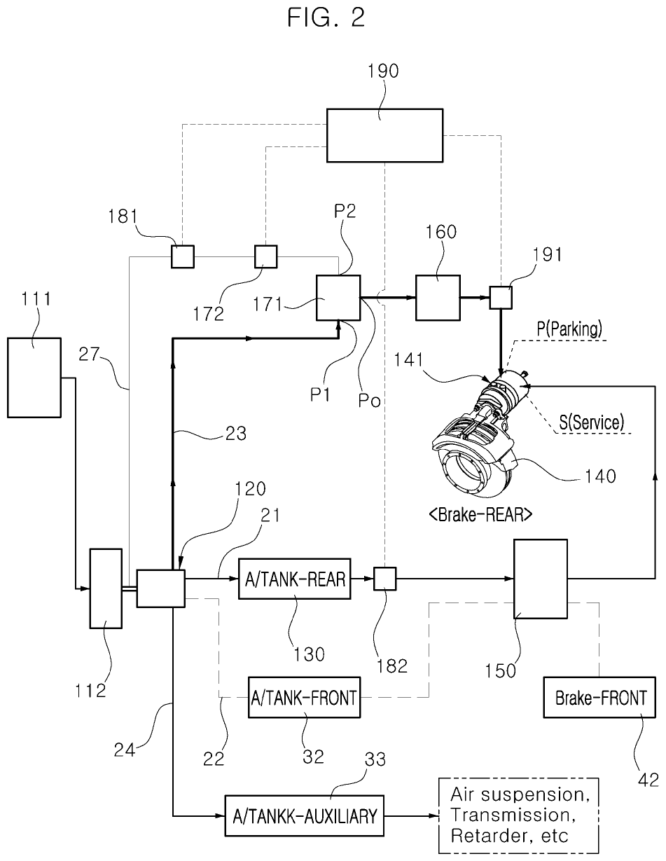

FIG. 2 schematically illustrates a system for controlling a parking brake according to an exemplary embodiment of the present disclosure.

Hereinafter, a system for controlling a parking brake according to an exemplary embodiment of the present disclosure will be described with reference to FIG. 2.

The system for controlling the parking brake according to an exemplary embodiment of the present disclosure is a system for improving a characteristic in which pressure formation of a parking brake flow path 23 is delayed compared to other circuits when a parking brake is applied and released, such as starting after stopping.

The system for controlling the parking brake according to an exemplary embodiment of the present disclosure includes an air compressor 111 that generates compressed air, an air dryer 112 that configured to remove moisture from the air supplied from the air compressor 111 and transmits the compressed air from the air compressor 111 to a pressure protection valve 120 according to system pressure, and a pressure protection valve 120.

Here, the system pressure means the pneumatic level of the pneumatic system after the air dryer 112, and the air dryer 112 controls the system pressure.

That is, when the compressed air accumulates in the pneumatic system and reaches a certain level (cut-out pressure), the compressed air is discharged through the exhaust port of the air dryer 112 by the governor in the air dryer to adjust the system pressure of the pneumatic system.

And when the level of compressed air in the pneumatic system is lowered to a certain level (cut-in pressure) due to the use of the compressed air caused by the driver's braking operation, the air dryer 112 transfers the compressed air generated in the air compressor 111 to the pneumatic system to adjust the system pressure of the pneumatic system.

The pressure protection valve 120 is connected to a service brake flow path 21 for supplying pneumatic pressure to a service port S of a spring brake chamber of a brake-rear 140 and a parking brake flow path 23 for supplying pneumatic pressure to a parking port P of the spring brake chamber and then is connected to a second brake flow path 22 for supplying pneumatic pressure to a brake-front and an auxiliary flow path 24 for supplying pneumatic pressure to an air suspension and the like. Thus, the pressure protection valve 120 is a four-circuit protection valve that opens or closes the corresponding flow path according to flow path pressure.

Furthermore, an air tank 130 is provided on the service brake flow path 21, and a brake valve 150 for controlling a service brake operation of the brake-rear 140 is provided on the service brake flow path 21.

The present disclosure configures an additional flow path in addition to four flow paths from the pressure protection valve 120 to improve the delay in releasing the parking brake.

An additional parking brake flow path 27, which is the additional flow path, is connected between the air dryer 112 and the pressure protection valve 120, and a solenoid valve 172 is provided on the additional parking brake flow path 27, and then a supply of pneumatic pressure to the additional parking brake flow path 27 is controlled by ON/OFF control of the solenoid valve 172 according to a controller 190.

The additional parking brake flow path 27 is connected to the parking brake flow path 23, and the parking brake flow path 23 and the additional parking brake flow path 27 are connected to two input ports P1 and P2 of a double check valve 171, respectively, so that a pneumatic pressure supply through the parking brake flow path 23 or a pneumatic pressure supply through the additional parking brake flow path 27 may be selectively performed.

The double check valve 171 connects a higher-pressure input port of the two input ports to an output port and supplies pneumatic pressure through a flow path connected from the output port Po to a parking port P of the brake-rear 140.

Furthermore, a parking valve 160 for controlling a parking brake operation of the brake-rear 140 and a parking switch 191 are provided on the flow path of the parking port P from the double check valve 171.

Next, an additional parking flow path pressure sensor 181 is provided on the additional parking brake flow path 27, and a service flow path pressure sensor 182 is provided on the air tank 130 on a service brake flow path 21.

A sensing pressure by the additional parking flow path pressure sensor 181 and the service flow path pressure sensor 182 is received by the controller 190 which opens or closes the solenoid valve 172 according to a control criteria described below. Furthermore, parking state is checked by receiving a parking ON/OFF signal through the parking switch 191.

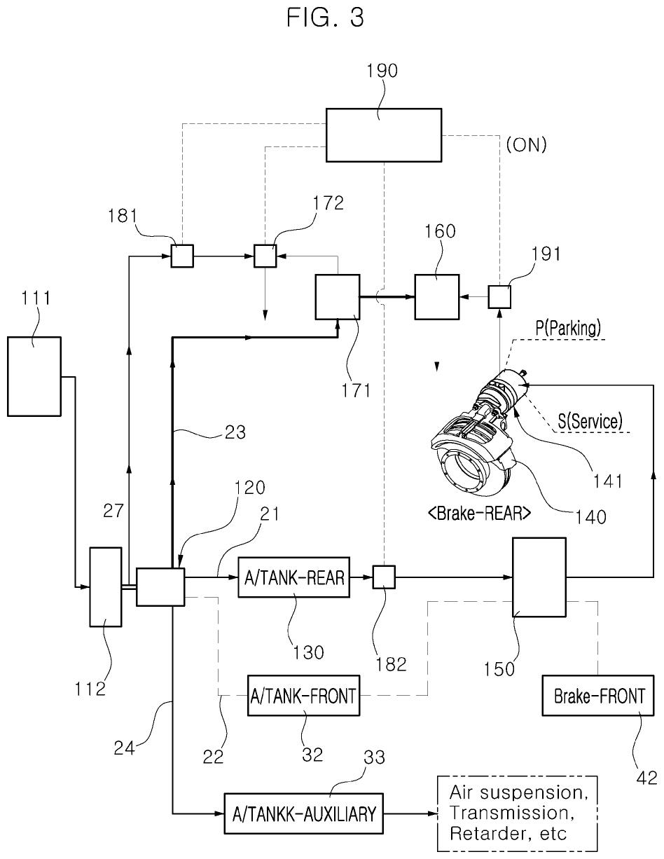

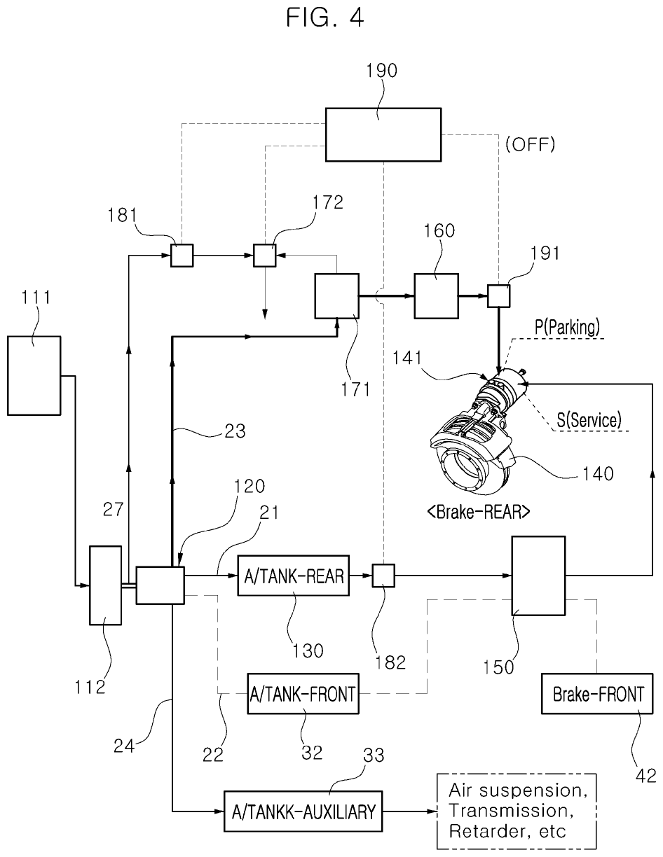

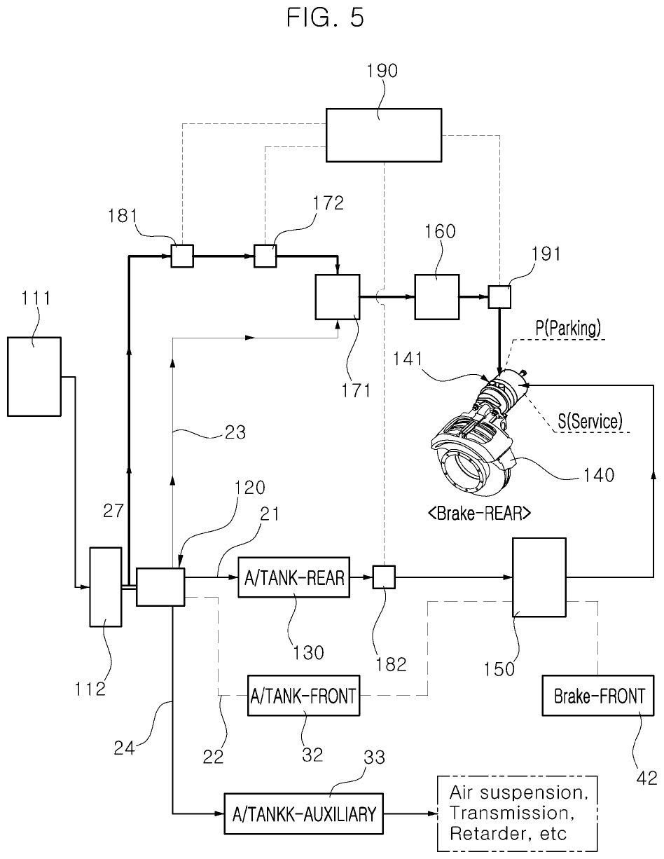

Next, a specific operating state of the system for controlling the parking brake of the present disclosure described above will be described with reference to FIG. 3, FIG. 4, and FIG. 5.

FIG. 3 and FIG. 4 are operating states when in a normal state, FIG. 3 is a state when the parking brake is applied, and FIG. 4 is a state when the parking brake is released.

Herein, a normal state is a case where flow path pressure of the parking brake flow path 23 is greater than or equal to an opening pressure of the service brake flow path 21.

First, when a driver operates a parking valve 160 to apply the parking brake, the solenoid valve 172 is the Off (close) state as illustrated in FIG. 3, and air pressure connected to the double check valve 171 is discharged to an exhaust port of the solenoid valve 172.

Furthermore, input pressure of the parking valve 160 is transmitted through the double check valve 171 as system pressure of the parking brake flow path 23, compressed air in the chamber is discharged to an exhaust port of the parking valve 160, and the parking brake is applied by spring (expansion) operation in a spring brake chamber 141.

Next, when a driver releases the parking valve 160 to the parking brake, the solenoid valve 172 maintains the Off (close) state as illustrated in FIG. 4, and the air pressure connected to the double check valve 171 is discharged to the exhaust port of the solenoid valve 172.

Furthermore, flow path pressure of the parking brake flow path 23 transmits compressed air to a parking port P of the spring brake chamber 141 through the double check valve 171 and the parking valve 160. Accordingly, the parking brake is released by spring compression.

FIG. 5 is an operating state operated by improving a release delay of a parking brake according to an exemplary embodiment of the present disclosure.

This is a case where the flow path pressure of the parking brake flow path 23 is lower than an opening pressure of the service brake flow path 21, which is not in the normal state as illustrated in FIG. 3 and FIG. 4.

That is, 1) The flow path pressure of the parking brake flow path 23 is lower than the opening pressure of the service brake flow path 21, 2) The parking brake is applied (parking switch ON), 3) When the parking valve 160 is released (parking switch OFF) for starting, a parking brake release is delayed to a wheel velocity=0 even when an accelerator pedal (Accel. PDL) is operated.

In the present state, the parking brake cannot be released until the flow path pressure of the parking brake flow path 23 is greater than or equal to an opening pressure.

At the present time, the controller 190 compares values of the additional parking flow path pressure sensor 181 and the service flow path pressure sensor 182, and operates the solenoid valve 172 when the pressure of the additional parking brake flow path 27 is greater than or equal to the pressure of the service brake flow path 21 or the air tank 130, compressed air of the additional parking brake flow path 27 passes through the double check valve 171 and then is transmitted to the spring brake chamber 141 through the parking valve 160.

Accordingly, the parking brake is released by being formed greater than or equal to a spring release pressure.

Thereafter, when the flow path pressure of the parking brake flow path 23 increases and exceeds the opening pressure, that is, when the pressure value of the additional parking brake flow path 27 becomes the opening pressure of the parking brake flow path 23, the controller 190 turns off the solenoid valve 172 to prevent compressed air from being transmitted to the double check valve 171 and compressed air between the double check valve 171 and the solenoid valve 172 is leaked to the exhaust port of the solenoid valve 172.

In the instant case, the pressure of the parking brake flow path 23 is transmitted to the parking valve 160 through the double check valve 171.

Furthermore, since an opening pressure for each circuit is managed by the controller, it may be compared to a value measured by the sensor and used for control.

Meanwhile, when the pressure of the service brake flow path 21 is less than the opening pressure (when system pressure is low), the solenoid valve 172 is not operated by the controller 190 until the pressure of the additional parking brake flow path 27 reaches the opening pressure of the service brake flow path 21 to ensure stability of a service brake operation.

That is, this is because a vehicle may be moved without a stable braking in a service brake apparatus, in a case where the system pressure is low, when the parking brake is released.

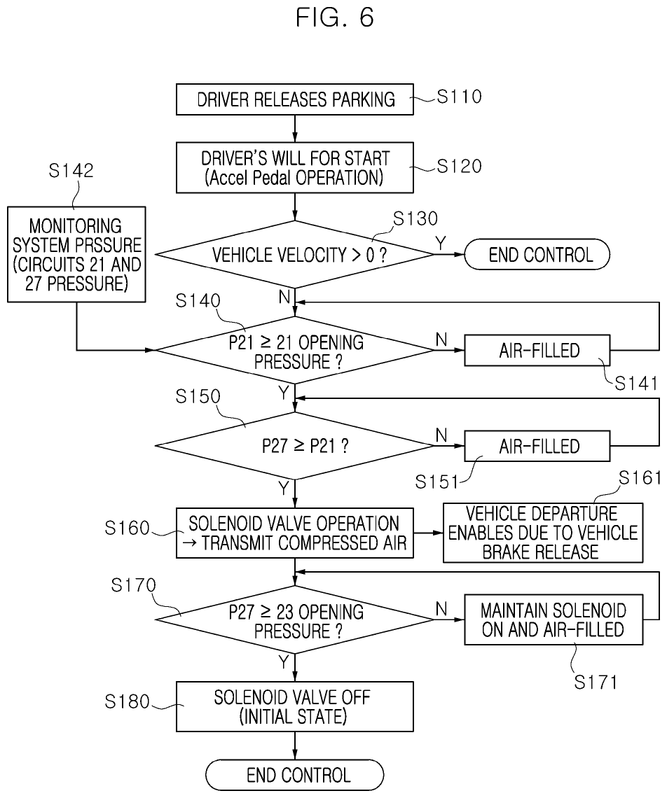

FIG. 6 illustrates a method of controlling release of a parking brake according to an exemplary embodiment of the present disclosure. With reference to this, a method of controlling release of a parking brake according to an exemplary embodiment of the present disclosure will be described.

First, when the parking brake is released by a driver releasing the parking valve 160 (S110), the driver's will to start is determined based on whether the accelerator pedal is operated (the amount of accelerator opening) (S120).

After the operation of the accelerator pedal, a vehicle velocity is determined (S130), and when the vehicle velocity is greater than 0, a control is terminated in a state in which release delay of the parking brake does not occur.

When the vehicle velocity is 0, it is determined whether a flow path pressure P21 of the service brake flow path 21 is greater than or equal to the opening pressure of the service brake flow path 21 (S140).

To the present end, the pressure of the additional parking brake flow path 27 and the service brake flow path 21 is monitored through the additional parking flow path pressure sensor 181 and the service flow path pressure sensor 182 for subsequent steps (S142).

As a result of determining S140, when the flow path pressure P21 of the service brake flow path 21 is less than the opening pressure of the service brake flow path 21, the system pressure is in a low state, and thus air is controlled to be filled in the air tank 130 (S141).

However, when the flow path pressure P21 of the service brake flow path 21 is greater than or equal to the opening pressure of the service brake flow path 21, it is determined whether the flow path pressure P27 of the additional parking brake flow path 27 is greater than or equal to the flow path pressure P21 of the service brake flow path 21 (S150).

As a result of the determination, when the flow path pressure P21 of the service brake flow path 21 is less than the opening pressure of the service brake flow path 21, the air is controlled to be filled as like S141 (S151).

However, when the flow path pressure P27 of the additional parking brake flow path 27 is greater than or equal to the flow path pressure P21 of the service brake flow path 21, the solenoid valve 172 is operated (ON) by being controlled, and compressed air of the additional parking brake flow path 27 flows through the double check valve 171 and then is transmitted to the spring brake chamber 141 through the parking valve 160 (S160).

Accordingly, the parking brake is released by being formed above a spring release pressure and then the vehicle is in a startable state (S161).

In the present way, after controlling release delay of the parking brake, it is determined whether the flow path pressure P27 of the additional parking brake flow path 27 is greater than or equal to the opening pressure of the parking brake flow path 23 (S170).

As a result of the determination, when the flow path pressure P27 of the additional parking brake flow path 27 is less than the opening pressure of the parking brake flow path 23, the solenoid operation ON state by the S160 is maintained and air-filled (S171).

However, when the flow path pressure P27 of the additional parking brake flow path 27 is greater than or equal to the opening pressure of the parking brake flow path 23, the solenoid valve is turned off (S180).

That is, a release delay control is terminated in a normal state in which a supply of compressed air through the parking brake flow path 23 is not delayed.

As described above, the present disclosure may rapidly improve release delay of the parking brake.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for controlling a parking brake, the system comprising:
an air compressor that generates compressed air, an air dryer that transmits the compressed air, and a pressure protection valve that supplies the compressed air from the air dryer to a service brake flow path connected to a spring brake chamber of a brake, a parking brake flow path, and an additional parking brake flow path connected between the air dryer and the pressure protection valve;
a double check valve including first and second inputs connected to the additional parking brake flow path and the parking brake flow path respectively, and transmitting a higher pressure among a first flow path pressure of the first input and a second flow path pressure of the second input through an output port of the double check valve; and
a parking valve which is provided on a flow path connected from the output port of the double check valve to a parking port of the spring brake chamber and is configured to control a parking brake operation of the brake.

2. The system of claim 1, further including:
a solenoid valve provided on the additional parking brake flow path; and
a controller electrically connected to the solenoid valve and configured for controlling a supply of the compressed air through the additional parking brake flow path by controlling the solenoid valve.

3. The system of claim 2, further including:
a parking switch provided on the flow path connected from the output port of the double check valve to the parking port to detect a parking brake operation state of the brake.

4. The system of claim 2, further including:
an additional parking flow path pressure sensor provided on the additional parking brake flow path to detect the first flow path pressure; and
a service flow path pressure sensor provided on the service brake flow path.

5. The system of claim 4, wherein the controller is configured to control the solenoid valve according to the first flow path pressure of the additional parking flow path pressure sensor and a flow path pressure of the service flow path pressure sensor.

6. The system of claim 5, wherein when the parking valve is operated, the controller is configured to turn off the solenoid valve to supply the compressed air to the parking valve through the parking brake flow path.

7. The system of claim 5, wherein when the parking valve is released after operation thereof, and accelerator pedal operation and vehicle velocity are detected as zero, the controller is configured to compare the first flow path pressure of the additional parking flow path pressure sensor and the flow path pressure of the service flow path pressure sensor.

8. The system of claim 7, wherein when the first flow path pressure of the additional parking brake flow path is greater than or equal to the flow path pressure of the service brake flow path, the controller is configured to turn on the solenoid valve to supply the compressed air to the parking port via the parking valve through the additional parking brake flow path.

9. The system of claim 7, wherein the controller is configured to turn on the solenoid valve to maintain turn-on state thereof when the flow path pressure of the service brake flow path is less than an opening pressure of the service brake flow path even in a state where the parking valve is released after operation thereof, accelerator pedal operation and vehicle velocity are detected as zero, and the first flow path pressure of the additional parking flow path is greater than or equal to the flow path pressure of the service brake flow path.

10. The system of claim 7, wherein after the controller turns on the solenoid valve, when the first flow path pressure of the additional parking flow path is greater than or equal to an opening pressure of the parking brake flow path, the controller is configured to turn off the solenoid valve to supply the compressed air to the parking valve through the parking brake flow path.

11. The system of claim 1, wherein the brake is a brake-rear.

12. A method of controlling release of the parking brake according to the system for controlling the parking brake of claim 4, the method comprising:
determining, by the controller, whether a vehicle velocity is greater than zero when the parking valve is released and accelerator pedal operation is detected;
comparing, by the controller receiving detection signal of the additional parking flow path pressure sensor and the service flow path pressure sensor, the first flow path pressure of the additional parking flow path and a flow path pressure of the service flow path in response that the controller concludes that the vehicle velocity is detected as zero; and
supplying, by the controller controlling the solenoid valve to turn on, the compressed air through the additional parking brake flow path in response that the controller concludes that the first flow path pressure of the additional parking brake flow path is greater than or equal to the flow path pressure of the service brake flow path.

13. The method of claim 12, further including:
comparing, by the controller, the first flow path pressure of the additional parking brake flow path with an opening pressure of the parking brake flow path after the supplying of the compressed air through the additional parking brake flow path; and
supplying, by the controller controlling the solenoid valve to turn off, the compressed air through the additional parking brake flow path in response that the controller concludes that the first flow path pressure of the additional parking flow path is greater than or equal to the opening pressure of the parking brake flow path.

14. The method of claim 12, further including:
determining whether the flow path pressure of the service brake flow path is greater than or equal to an opening pressure of the service brake flow path before the comparing of pressure values by the additional parking flow path pressure sensor and the service flow path pressure sensor when the vehicle velocity is detected as zero by the determining of whether the vehicle velocity is greater than zero,
wherein when the flow path pressure of the service brake flow path is greater than or equal to the opening pressure of the service brake flow path, comparing the first flow path pressure of the additional parking flow path pressure sensor and the flow path pressure of the service flow path pressure sensor is performed.

15. A non-transitory computer readable storage medium on which a program for performing the method of claim 12 is recorded.
